(19) United States
(12) Patent Application Publication
(10) Pub. No.: US 2010/0328873 A1
(43) Pub. Date: Dec. 30, 2010

(54) MONITOR

(75) Inventors: Lei Liu, Shenzhen City (CN); Shu-Ni Yi, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/545,039

(22) Filed: Aug. 20, 2009

(30) Foreign Application Priority Data
Jun. 25, 2009 (CN) 200910303689.4

(51) Int. Cl. G06F 1/16; G02F 1/1333

(52) U.S. Cl. 361/679.21; 349/58

(57) ABSTRACT

A monitor comprises a back cover defining a depressed portion to receive a hard disk, a motherboard, and a power supply. The depressed portion comprises a bottom board and a side wall connected between the bottom board and a baseboard of the back cover. An opening corresponding to a plurality of input/output interfaces of the motherboard is defined in the side wall of the depressed portion.

### BACKGROUND

1. Technical Field

The present disclosure relates to monitors, and particularly to a monitor combined with a motherboard.

2. Description of Related Art

With computers becoming smaller and smaller, a kind of mini information technology extended (ITX) motherboard with a size of 170 mm*170 mm has been developed. The mini ITX motherboard is easy to be installed in a relatively small space, and thereby a mini enclosure is provided to match the mini ITX motherboard. However, although the mini enclosure occupies little space, it is still inconvenient to be transported separately from a monitor.

### BRIEF DESCRIPTION OF THE DRAWINGS

FIG. 1 is an exploded, isometric view of an exemplary embodiment of a monitor.

FIG. 2 is similar to FIG. 1, but viewed from another perspective.

FIG. 3 is a front view of a back cover of the monitor of FIG. 1.

FIG. 4 is similar to FIG. 3, but showing the back cover being installed with a motherboard, a hard disk, and a power supply.

FIG. 5 is an assembled view of the monitor of FIG. 1.

### DETAILED DESCRIPTION

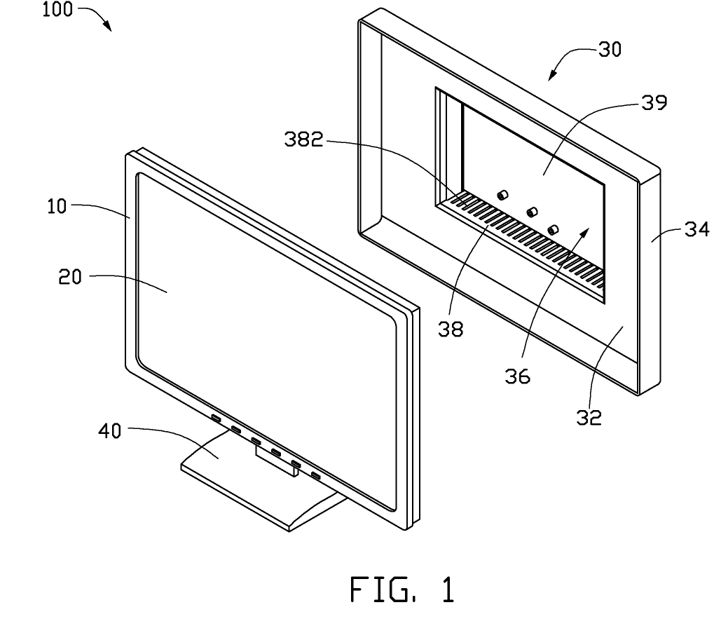

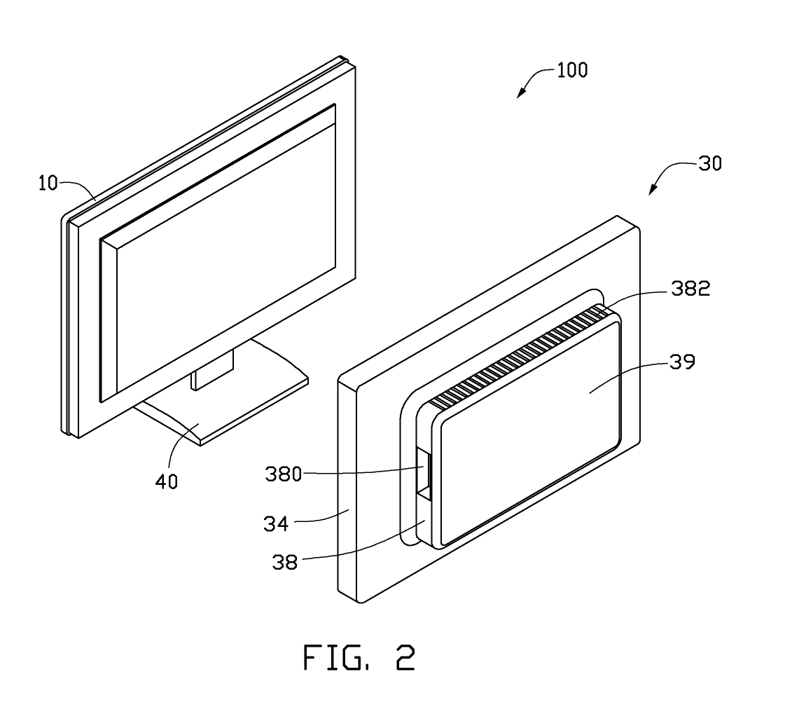

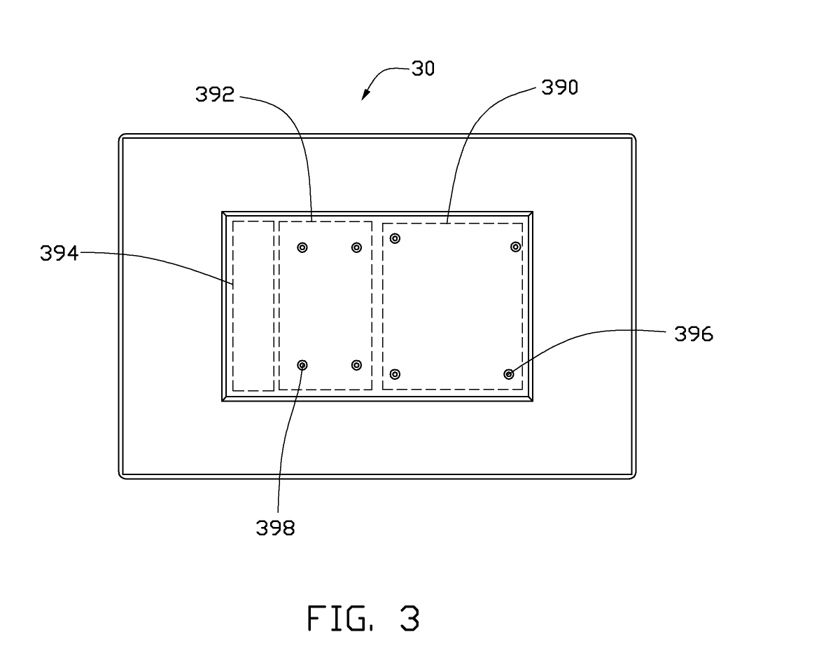

Referring to FIGS. 1-3, an exemplary embodiment of a monitor 100 includes a front cover 10, a liquid crystal display (LCD) 20, a back cover 30, and a holder 40. The LCD 20 is fixed to the front cover 10. The back cover 30 is fixed to the front cover 10, to cover a rear of the LCD 20. The holder 40 is located under the front cover 10 to support the assembly of the front cover 10, the LCD 20, and the back cover 30.

The back cover 30 includes a rectangular baseboard 32. Four sideboards 34 vertically extend from four sides of the baseboard 32. A rectangular depressed portion 36 is formed in a center of the baseboard 32 facing the front cover 10. The depressed portion 36 includes a bottom board 39 parallel to the baseboard 32, and a side wall 38 perpendicularly connected between the bottom board 39 and the baseboard 32. A rectangular opening 380 and a plurality of air outlets 382 are defined in the side wall 38.

The bottom board 39 includes a first location 390 for mounting a mini information technology extended (ITX) motherboard, a second location 392 for mounting a hard disk drive, and a third location 394 for mounting a power supply. A plurality of I/O interfaces of the mini ITX motherboard may be exposed through the opening 380. Four pillars 396 each axially defining a screw hole therein extend from the first location 390 towards the front cover 10, to fix the ITX motherboard. Four pillars 398 each axially defining a screw hole therein extend from the second location 392 towards the front cover 10, to fix the hard disk drive.

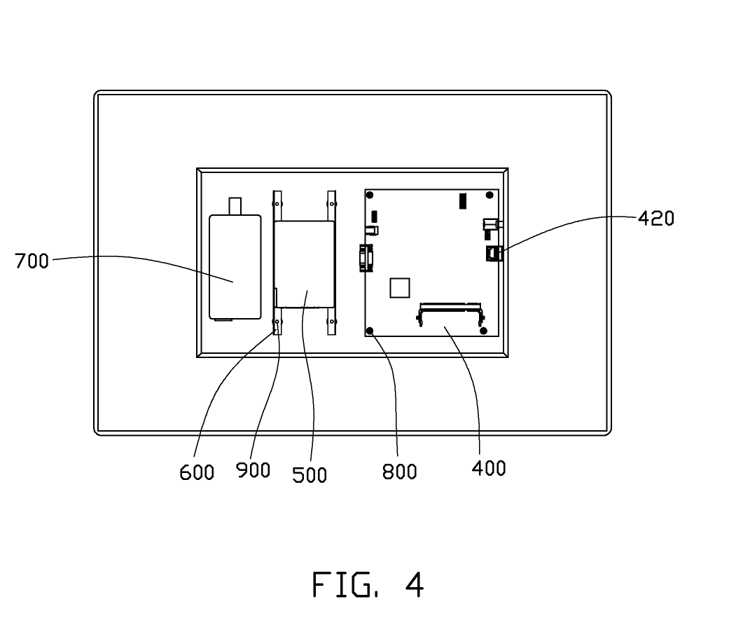

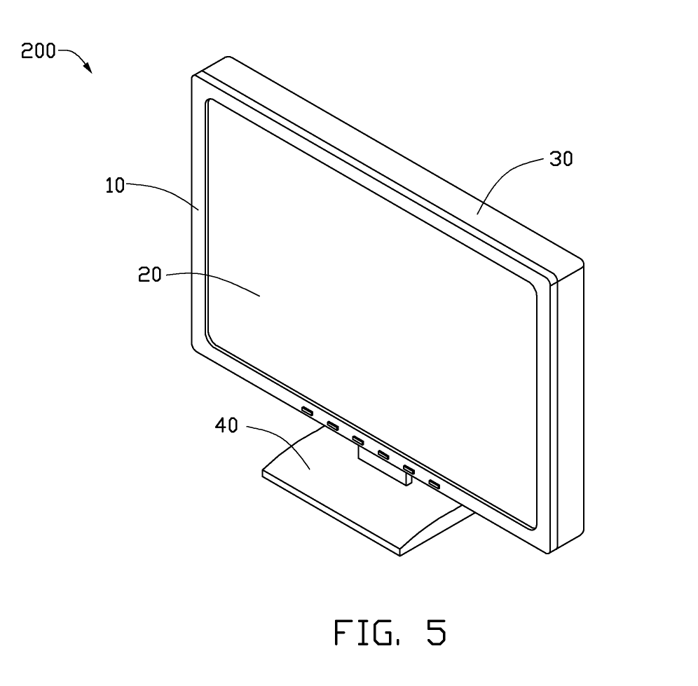

Referring to FIG. 4 and FIG. 5, in assembly, four screws 800 extend through four through holes of a mini ITX motherboard 400, to be screwed into the screw holes of the corresponding pillars 396 of the first location 390, thereby fixing the mini ITX motherboard 400 to the bottom board 39 of the back cover 30. A plurality of I/O interfaces 420 of the mini ITX motherboard 400 are exposed through the opening 380, thereby peripheral equipment such as a keyboard and a mouse can be conveniently connected to the plurality of I/O interfaces 420. Since different kinds of mini ITX motherboards have different I/O interfaces, users can select different I/O baffles to cooperate with the opening 380 to connect to peripheral equipment.

Four screws 900 pass through screw holes defined in two brackets 600 of a hard disk drive 500 and are screwed in the screw holes of the corresponding pillars 398 of the second location 392, thereby fixing the hard disk drive 500 to the second location 392 of the bottom board 39. A power supply 700 can be fixed to the third location 394 of the bottom board 39, according to the same method mentioned above.

In another exemplary embodiment, the hard disk drive 500 and the power supply 700 can be fixed to the depressed portion 36 via other fixing devices, such as rivets. The back cover 30 covers the LCD 20, with the four sideboards 34 of the back cover 30 being fixed to the front cover 10.

After the monitor 100 is assembled, the monitor 100, the peripheral equipment, and the mini ITX motherboard 400 are connected via lines. The power supply 700 supplies power to the mini ITX motherboard 400, the hard disk drive 500, and the peripheral equipment. Thereby, an integrated computer system 200 is obtained, and the inconvenience of having a monitor and a separate enclosure is eliminated.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A monitor, comprising:
a front cover;
a liquid crystal display (LCD) fixed to the front cover; and
a back cover fixed to the front cover to cover a rear of the LCD; wherein the back cover comprises a baseboard defining a depressed portion facing the LCD, to receive a hard disk, a motherboard, and a power supply; wherein the depressed portion comprises a bottom board opposite to the LCD and a side wall connected between the bottom board and the baseboard; wherein an opening corresponding to a plurality of input/output interfaces of the motherboard is defined in the side wall of the depressed portion.

2. The monitor of claim 1, wherein the bottom board of the depressed portion comprises a first location for mounting the motherboard, a second location for mounting the hard disk, and a third location for mounting the power supply.

3. The monitor of claim 2, wherein a plurality of pillars each defining a screw hole protrude from the first location of the bottom board towards the LCD, to fix the motherboard.

4. The monitor of claim 2, wherein a plurality of pillars each defining a screw hole protrude from the second location of the bottom board towards the LCD, to fix the hard disk drive.

5. The monitor of claim 1, wherein the side wall further defines a plurality of air outlets.

6. The monitor of claim 1, wherein a plurality of sideboards vertically extend from corresponding sides of the baseboard, to be fastened to the front cover.

7. A computer system, comprising:
a motherboard;
a hard disk drive;
a power supply; and
a monitor comprising:
a front cover;
a liquid crystal display (LCD) fixed to the front cover; and
a back cover fixed to the front cover to cover a rear of the LCD; wherein the back cover defines a receiving space facing the LCD to receive the hard disk drive, the motherboard, and the power supply.

8. The computer system of claim 7, wherein the back cover comprises a baseboard facing the LCD, and a plurality of sideboards substantially extending from sides of the base board to connect the back cover to the front cover.

9. The computer system of claim 8, wherein the depressed portion is defined in the baseboard and comprises a bottom board opposite to the LCD, and a side wall connected between the bottom board and the baseboard, wherein the bottom board comprises a first location for mounting the motherboard, a second location for mounting the hard disk drive, and a third location for mounting the power supply.

10. The computer system of claim 9, wherein a plurality of pillars each defining a screw hole protrude from the first location of the bottom board towards the LCD; wherein the motherboard is fixed to the bottom board via a plurality of screws passing through the motherboard to screw in the screw holes of the plurality of the pillars.

11. The computer system of claim 9, wherein a plurality of pillars each defining a screw hole protrude from the second location of the bottom board; wherein the hard disk drive is fixed to the bottom board via a plurality of screws passing through the hard disk drive to screw in the screw holes of the plurality of pillars.

12. The computer system of claim 9, wherein the side wall defines a plurality of air outlets.

13. The computer system of claim 9, wherein the side wall defines an opening, the motherboard comprises an input/output port, to expose through the opening.
